(19) United States
(12) Patent Application Publication
(10) Pub. No.: US 2004/0103799 A1
(43) Pub. Date: Jun. 3, 2004

(54) Main drive and convert mechanism in a platen press with a flat auto-die for cutting and gilding

(76) Inventor: Tian-Sheng Liu, Pan-Chiao City (TW)

Correspondence Address: Tian-Sheng Liu, P.O. Box No. 6-57, Chung-Ho, Taipei, 235, TW

(21) Appl. No.: 10/307,452

(22) Filed: Dec. 2, 2002

(51) Int. Cl. B31F 1/07

(52) U.S. Cl. 101/28

(57) ABSTRACT

A main drive and convert mechanism in a platen press with a flat auto-die for cutting and gilding including a machine mount, a power platen as well as four sets of upper shaft seats and toggle rod upper shafts connected with the power platen is characterized that four sets of conjugate cams and four sets of lower toggle rod drive gears are installed between the four sets of toggle rod upper shafts and the machine mount. The advantages of the present invention are that, first, converting the rotary movement of the conjugate cams to an up-and-down linear movement of the power platen thereby accelerating the ascending and descending speed of the power platen as well as having special pressing time for continuously pressing convexes and gilding. Second, enhancing the process quality and quantity as well as the production effect. Third, being excellent practicality, economies and potential developing prospects.

### BACKGROUND OF THE INVENTION

1) Field of the Invention

The present invention relates to an after-printing mechanical equipment, more particularly to a main drive and convert mechanism in a platen press with a flat auto-die for cutting and gilding capable of converting a rotary movement of a shaft to an up-and-down linear movement of a platen.

2) Description of the Prior Art

Recently, the development of the printing and packaging business demands better after-printing equipment not only for precision, but also for fast speed. However, the equipment speed is limited by a drive structure of an original mechanism. It is more obvious in the technique of pressing the convexes and gilding. First, the highest point of a power platen requires a certain time for continuous pressing. It is impossible to implement this process in a crank shaft and link gear. Second, it is hard to accelerate the ascending and descending speed of the power platen in an original mechanism. The said two shortcomings limit the development of the high-speed gilding and printing machine. Therefore, the available platen press for printing and gilding still only process about 3500 to 5000 sheets per hour. It is possible to merely increase the speed. However, due to the special demand of gilding and convex pressing, more especially for gilding, high temperature and high pressure are used to transfer the electrified aluminum foil onto paper product. The transferring and printing techniques won't finish radically if the time available is too short. That might cause mis-gilding also. Increasing the temperature has the risk of burning the material and generating undesired products without luster. Therefore, the original drive and convert mechanism including the crank shaft, links, etc. fails to satisfy the requirements for accelerating the machine operation, assuring the quality and quantity of convex pressing and gilding. The present drive and convert mechanism, as indicated in FIG. 1A and FIG. 1B, comprises a power platen, an upper toggle rod, a crank shaft, a link and a lower toggle rod. The input power makes a rotary movement of the crank shaft drive the link to sway left-and-right via the bending of the crank shaft. The other end of the link drives the upper and lower toggle rods to sway up-and-down in circular arcs; finally, the power platen makes linear movements up-and-down. Since it is impossible to have a dwell time at the highest point of the power platen in this structure, the link is elongated to allow the middle line thereof in sway procedure to pass the highest dead point for continuous pressing. Although it achieves a certain effect, derived adverse parameters might cause negative effects, such as smoldering machine, affected speed and undesired force bearing on the upper and lower toggle rods of the link.

### SUMMARY OF THE INVENTION

Therefore, the primary objective of the present invention is to design a main drive and convert mechanism in a platen press with a flat auto-die for cutting and gilding; the present invention converts a rotary movement of a shaft in an equipment to an up-and-down linear movement of a platen so as to solve the problems of assuring the quality and quantity of the convex pressing and gilding as well as accelerating the speed of the machine.

The present invention comprising a machine mount, a power platen as well as four sets of upper shaft seats and toggle rod upper shafts connected with the power platen is characterized that four sets of conjugate cams and four sets of lower toggle rod drive gears are installed between the four sets of toggle rod upper shafts and the machine mount.

The four sets of conjugate cams and the four sets lower toggle rod drive gears are installed between the four sets of toggle rod upper shafts and the machine mount as well as the four sets lower toggle rods; wherein the four sets of conjugate cams comprise a drive shaft and four conjugate cams; the four conjugate cams are symmetrically disposed in two sets on the drive shaft via a division bush and a tension bush. Each set of cams has two cam trays with different curve lines. Said four sets of lower toggle rod drive gears comprise an upper toggle rod fitting the toggle rod upper shaft, a toggle rod middle shaft, a lower toggle rod, a toggle rod lower shaft, an upper roller and a lower roller disposed at two ends of each lower toggle rod. The lower toggle rod is a rod with a right angle; the lower end of the upper rod connects with the upper end of the lower toggle rod via the toggle rod middle shaft; the right angle end of the lower toggle rod connects with the toggle rod lower shaft; an upper roller and a lower roller are respectively disposed at two ends of each lower toggle rod. The upper and lower rollers at the two ends of each set of lower toggle rods and the two cam trays with different curve lines disposed on each set of cams of the four sets of the conjugate cams contact by rolling.

The abovementioned four sets of conjugate cams are a right front descending cam, a right front ascending cam, a left front ascending cam, a lest front descending cam, a right rear descending cam, a right rear ascending cam, a left rear ascending cam and a left rear descending cam.

A lower seat adjusting plate with adjustable height is disposed under a lower shaft seat at the bottom portion of the toggle rod lower shaft connected at said lower end of the lower toggle rod.

The main drive and convert mechanism comprises a power platen, an upper toggle rod, a conjugate cam set, a drive shaft and a lower toggle rod. The drive shaft inputs the rotary power to drive four sets of conjugate cams for rotation; wherein a set of conjugate cam contacts two sets of upper and lower rollers of the lower toggle rod; the cam makes rotary movement. The upper roller of the lower toggle rod ascends to sway and the lower roller descends to sway. Each time the drive shaft rotates one circle, the lower toggle rod finishes two periodically ascending and descending movements. Since the circular arc at a long diameter area of the conjugate came is an equi-circular arc, the power platen has obvious dwell times at the two ends (the highest and lowest points). That is the continuous pressing time required by the convex pressing and gilding technique. The principle is that the design of the equi-circular arc at the long diameter end of the conjugate cam determines the ultimate dwell time of the power platen at the upper or lower limits (the highest or the lowest points). In addition, the variation from the long diameter to the short diameter of the cam tremendously increases the ascending and descending speed of the power platen thereby satisfying the demand of the special technique of pressing the convexes and gilding; that means, to accelerate the ascending and descending speed of the power platen as well as to have dwell time at the highest point thereof. The original working condition of the power platen is to use the cam and link mechanism to drive its ascending movement and let its own gravity cause the descending movement; since the conjugate cam controls the ascending descending procedure of the power platen, it improves the original working condition of the power platen. That means, all of the ascending, descending and dwelling of the power platen are controlled by the conjugate cam so as to radically change the dynamic situation of the power platen thereby achieving a desired technical effect.

The advantages of the present invention are that, first, an ingenious idea converts the rotary movement of the conjugate cams to an up-and-down linear movement of the power platen thereby accelerating the ascending and descending speed of the power platen so as to smoothly achieve the objective of having enough dwell time when the power platen either at the highest point or at the lowest point, and to accelerate the ascending and descending speed of the power platen by increasing the original speed of printing 4500 sheets per hour to about 6500 to 7000 sheets per hour. That speed surpasses the limit of printing less than 6000 sheets per hour in the past one hundred years. The present invention not only tremendously enhances the quality of the operation, but also satisfies the technical requirement of having special pressing time for continuously pressing convexes and gilding. Second, the structure is simple and compact; the equipment operates with augmented ability so as to enhance the process quality and quantity as well as the production effect. Third, the present invention has excellent practicality, economies and potential developing prospects.

To enable a further understanding of the structural features and the technical contents of the present invention, the brief description of the drawings below is followed by the detailed description of the preferred embodiment.

### BRIEF DESCRIPTION OF THE DRAWINGS

FIG. 1A is a schematic drawing of the structure of a conventional crank shaft link drive and convert mechanism.

FIG. 1B is a schematic drawing of the conventional crack shaft structure.

FIG. 2 is a schematic drawing of the whole structure of the present invention of a main drive and convert mechanism in a platen press with a flat auto-die for cutting and gilding.

FIG. 3 is an enlarged and schematic drawing of a conjugate cam set (the set A in FIG. 2) of the present invention of a main drive and convert mechanism in a platen press with a flat auto-die for cutting and gilding.

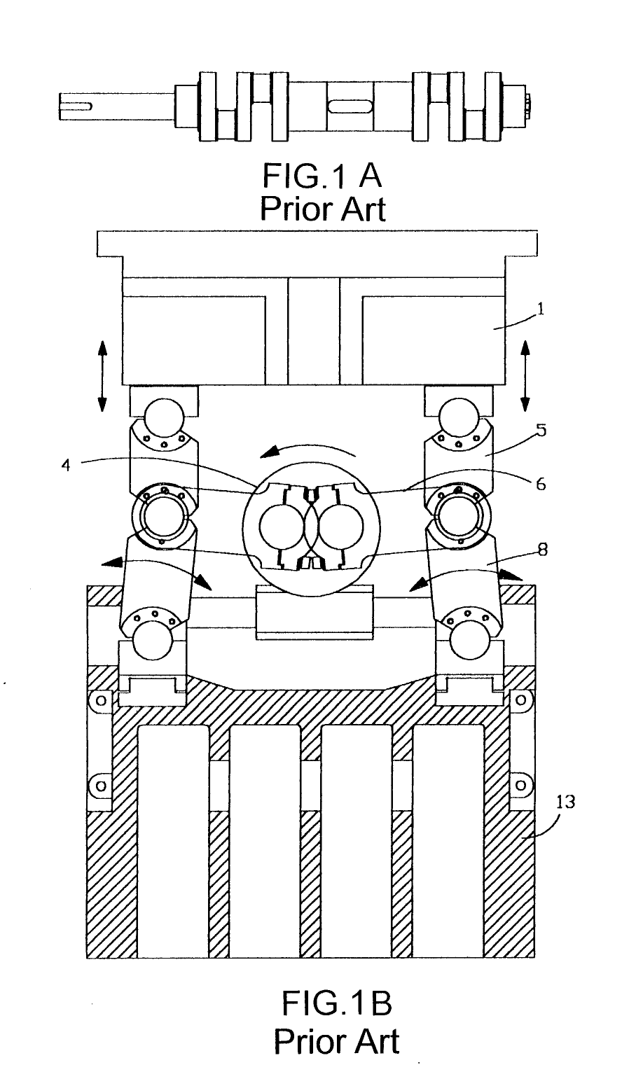

### DETAILED DESCRIPTION OF THE PREFERRED EMBODIMENTS

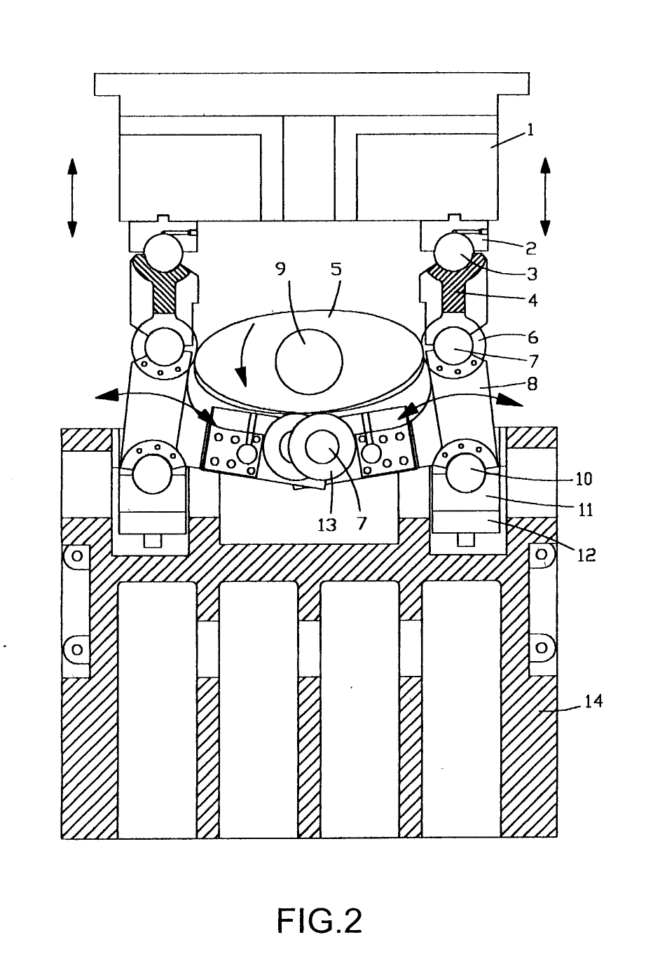

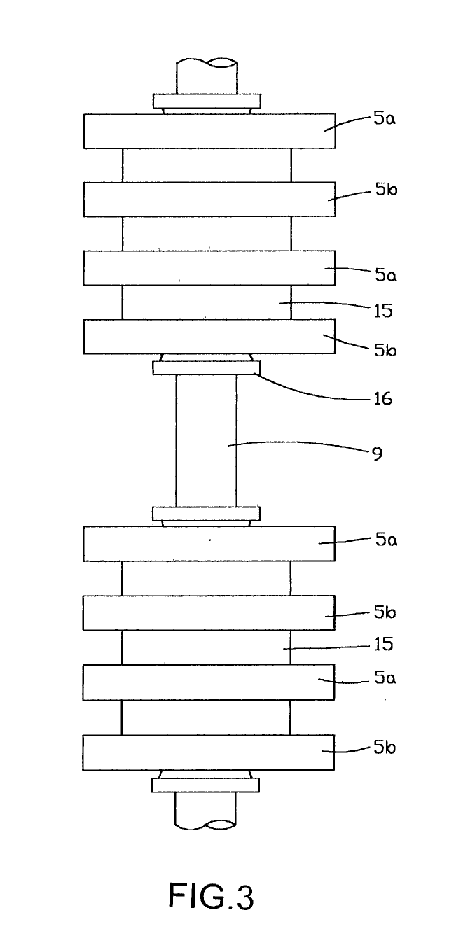

Referring to FIGS. 2 and 3, the present invention of a main drive and convert mechanism in a platen press with a flat auto-die for cutting and gilding comprising a machine mount (14), a power platen (1) as well as four sets of upper shaft seats (2) and toggle rod upper shafts (3) connected with the power platen (1) is characterized that four sets of conjugate cams (5) and four sets of lower toggle rod drive gears are installed between the four sets of toggle rod upper shafts (3) and the machine mount (14). The four sets of conjugate cams (5) comprise a drive shaft (9) and four conjugate cams (5a, 5b); the four conjugate cams (5a, 5b) are symmetrically disposed in two sets on the drive shaft (9) via a division bush (15) and a tension bush (16). Each set of cams has two cam trays (5a, 5b) with different curve lines. Said four sets of lower toggle rod drive gears comprise an upper toggle rod (4) fitting the toggle rod upper shaft (3), a toggle rod middle shaft (7), a lower toggle rod (8) in the shape of a right angle, a toggle rod lower shaft (10), an upper roller (6) and a lower roller (13) disposed at two ends of each lower toggle rod (8) in the shape of a right angle. Via the toggle rod middle shaft (7), the lower end of the a lower shaft of the upper toggle rod (4) connects with the lower toggle rod (8) in the shape of a right angle disposed respectively with an upper roller (6) and a lower roller (13) at two ends thereof. The upper and lower rollers (6, 13) at the two ends of each set of lower toggle rod (8) in the shape of a right angle and the two cam trays (5a, 5b) with different curve lines disposed on each set of cams of the four sets of the conjugate cams (5) contact by rolling.

The abovementioned four sets of conjugate cams (5a, 5b) are respectively installed on the driving side and the operation side of the equipment. The installation relation includes a right front descending cam (5a), a right front ascending cam (5b), a left front ascending cam (5b), a lest front descending cam (5a), a right rear descending cam (5a), a right rear ascending cam (5b), a left rear ascending cam (5b) and a left rear descending cam (5a).

A lower seat adjusting plate (12) with adjustable height is disposed under a lower shaft seat (11) at the bottom portion of the toggle rod lower shaft (10) connected with said right angle end of the lower toggle rod (8) in the shape of a right angle.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A main drive and convert mechanism in a platen press with a flat auto-die for cutting and gilding comprising a machine mount, a power platen as well as four sets of upper shaft seats and toggle rod upper shafts connected with the power platen is characterized that four sets of conjugate cams and four sets of lower toggle rod drive gears are installed between the four sets of toggle rod upper shafts and the machine mount.

2. The main drive and convert mechanism in a platen press with a flat auto-die for cutting and gilding according to claim 1, wherein the four sets of conjugate cams comprise a drive shaft and four conjugate cams; the four conjugate cams are symmetrically disposed in two sets on the drive shaft via a division bush and a tension bush; each set of cams has two cam trays with different curve lines; said four sets of lower toggle rod drive gears comprise an upper toggle rod fitting the toggle rod upper shaft, a toggle rod middle shaft, a lower toggle rod, a toggle rod lower shaft, an upper roller and a lower roller disposed at two ends of each lower toggle rod; the lower toggle rod is a rod with a right angle; the lower end of the upper rod connects with the upper end of the lower toggle rod via the toggle rod middle shaft; the right angle end of the lower toggle rod connects with the toggle rod lower shaft; an upper roller and a lower roller are respectively disposed at two ends of each lower toggle rod; the upper and lower rollers at the two ends of each set of lower toggle rods and the two cam trays with different curve lines disposed on each set of cams of the four sets of the conjugate cams contact by rolling.

3. The main drive and convert mechanism in a platen press with a flat auto-die for cutting and gilding according to claim 2, wherein the four sets of conjugate cams are a right front descending cam, a right front ascending cam, a left front ascending cam, a lest front descending cam, a right rear descending cam, a right rear ascending cam, a left rear ascending cam and a left rear descending cam.

4. The main drive and convert mechanism in a platen press with a flat auto-die for cutting and gilding according to claim 2, wherein a lower seat adjusting plate with adjustable height is disposed under a lower shaft seat at the bottom portion of the toggle rod lower shaft connected at said lower end of the lower toggle rod.
